(19) United States
(12) Patent Application Publication
(10) Pub. No.: US 2025/0162164 A1
(43) Pub. Date: May 22, 2025

(54) REALISTIC EYEBALL AND ROBOT

(71) Applicant: 3ASCREEN CORPORATION, New Taipei City (TW)

(72) Inventors: YI-Hau SHIAU, New Taipei City (TW); Shao-Lun HUANG, New Taipei City (TW); Chao-Chi CHUNG, New Taipei City (TW)

(21) Appl. No.: 18/637,924

(22) Filed: Apr. 17, 2024

(30) Foreign Application Priority Data
Nov. 17, 2023 (TW) 112144586

(51) Int. Cl. B25J 11/00; G09G 3/00

(52) U.S. Cl. CPC B25J 11/0015; G09G 3/035

(57) ABSTRACT

A realistic eyeball and a robot. The realistic eyeball includes a first lens unit, a spherical display unit and a sensing unit. The first lens unit has an inner concave surface. The spherical display unit is disposed on the inner concave surface of the first lens unit, and the spherical display unit has a display surface. The display surface includes a pupil area and an iris area surrounding the pupil area. The pupil area or the iris area has at least one penetration region. The sensing unit is disposed on the spherical display unit, and the sensing unit is disposed corresponding to the position of the at least one penetration region. The pupil area and the iris area have different patterns and colors according to different simulated animals.

### CROSS REFERENCE TO RELATED APPLICATIONS

This Non-provisional application claims priority under 35 U.S.C. § 119 (a) on Patent Application No(s). 112144586 filed in Taiwan, Republic of China on Nov. 17, 2023, the entire contents of which are hereby incorporated by reference.

### BACKGROUND

### Technology Field

The present disclosure relates to an artificial eyeball and a robot, and in particular, to a realistic eyeball and a robot with the realistic eyeball.

### Description of Related Art

Due to the intensive development of various robot manufacturers, in addition to basic mobile functions, service robots have also developed many types of functions, such as disinfection robots born in response to the needs of the epidemic (e.g. COVID-19), transport robots to assist in carrying heavy objects, chat robots that can chat with users, etc. The service robots are ready to integrate into our lives, taking on boring and repetitive tasks for people. The robots do not need to rest and can be on duty 24 hours per day, which not only reduces business costs, but also allows people to focus more on creating service values.

In addition, the number of newborns is declining year by year, and instead, more and more people are keeping pets. According to statistics, the number of new pet registrations has exceeded the number of newborns in recent years. The benefits of keeping pets are numerous, such as reducing stress and anxiety. Moreover, taking pets out for a walk can also increase the amount of exercise. Some studies have pointed out that keeping pets can reduce depression and loneliness. However, the life spans of most pets are shorter than that of humans. When a pet passes away, it may take the owner some time to recover from the pain.

The eyes of conventional service robots or pet robots are mostly just decorations. In some conventional service robots or pet robots, the displayed eye is a simple eye pattern (e.g. a black dot in a circle to represent the pupil). In some other conventional service robots or pet robots, a camera is installed in the eye to obtain images, which is a quite simple function. The eyes of conventional service robots or pet robots cannot realistically resemble the eyes of humans or different animals (i.e., have patterns and/or color changes corresponding to individuals or specific animals), and cannot express emotions.

### SUMMARY

An objective of the present disclosure is to provide a realistic eyeball and a robot with the realistic eyeball that can simulate patterns and/or color changes of real eye. In addition, when the realistic eyeball is viewed from outside, the pattern displayed by the realistic eyeball is not distorted.

To achieve the above, a realistic eyeball of this disclosure includes a first lens unit, a spherical display unit and a sensing unit. The first lens unit has an inner concave surface. The spherical display unit is disposed on the inner concave surface of the first lens unit. The spherical display unit has a display surface. The display surface includes a pupil area and an iris area surrounding the pupil area, and at least one of the pupil area and the iris area has at least one penetration region. The sensing unit is disposed on the spherical display unit, and the sensing unit is disposed corresponding to a position of the at least one penetration region. The pupil area and the iris area have different patterns and colors according to different simulated animals.

In one embodiment, the spherical display unit further comprises a plurality of pixels arranged on a display substrate, and the display substrate is stretchable, flexible or bendable.

In one embodiment, the spherical display unit is an LED display device, an OLED display device, an LCD device, or an e-paper display device.

In one embodiment, the curvature radius of a spherical curved surface of the spherical display unit is substantially equal to the curvature radius of a spherical curved surface of the inner concave surface.

In one embodiment, the realistic eyeball further includes an adhesive layer, which is disposed between the display surface and the inner concave surface.

In one embodiment, the realistic eyeball further includes a filling unit, the spherical display unit further includes a back surface opposite to the display surface, and the filling unit is attached to the back surface.

In one embodiment, the penetration region is configured with a first through hole, the filling unit is configured with a second through hole communicating with the first through hole, the sensing unit is disposed in the first through hole via the second through hole, and a top surface of the sensing unit faces an opening of the first through hole.

In one embodiment, the penetration region is configured with a plurality of pixels, the filling unit includes a second through hole, the sensing unit is disposed at the back surface via the second through hole, and a top surface of the sensing unit faces the penetration region.

In one embodiment, a part of each of the pixels in the penetration region is a transparent area, and the transparent areas define the penetration region.

In one embodiment, the penetration region is a transparent area and is configured without any pixel, the spherical display unit further includes a back surface opposite to the display surface, the sensing unit is disposed on the back surface, and a top surface of the sensing unit faces the penetration region.

In one embodiment, the sensing unit includes a sensor, and the sensor includes a visible-light sensor, an infrared sensor, or an ultrasonic sensor, or a combination thereof.

In one embodiment, the sensor includes a camera, a light detector, or a distance detector, or a combination thereof.

In one embodiment, the spherical display unit includes a display substrate, the display substrate has a plurality of pixels, and when the sensing unit includes an infrared sensor, the display substrate is permeable by an infrared light.

In one embodiment, at least one of the pupil area and the iris area has a plurality of the penetration regions, the sensing unit includes sensors of different types, and the sensors of different types are arranged in the penetration regions, respectively.

In one embodiment, the display surface further includes a sclera area surrounding the iris area, and each of the pupil area, the iris area and the sclera area displays one of the patterns and one of the colors.

In one embodiment, the realistic eyeball further includes a control circuit board electrically connected to the spherical display unit and the sensing unit, the control circuit board includes a database, and the database stores a plurality of the patterns and colors of the pupil area and the iris area.

In one embodiment, the realistic eyeball further includes a control unit electrically connected to the sensing unit and the spherical display unit. The sensing unit includes a light sensor, the light sensor receives a light passing through the first lens unit and the penetration region and outputs a sensing signal, and the control unit changes a dimension of the pupil area and a dimension of the iris area of the display unit based on the sensing signal.

In one embodiment, when the dimension of the pupil area decreases, the dimension of the iris area increases; or when the dimension of the pupil area increases, the dimension of the iris area decreases.

In one embodiment, the realistic eyeball further includes a functional layer, the first lens unit further includes an outer convex surface opposite to the inner concave surface, and the functional layer is disposed on the outer convex surface.

In one embodiment, the realistic eyeball further includes a second lens unit, the first lens unit further includes an outer convex surface opposite to the inner concave surface, the outer convex surface includes a recess located corresponding to the pupil area and the iris area, and the second lens unit is disposed in the recess. In one embodiment, in a top-view direction of the realistic eyeball, an area of the second lens unit is substantially equal to a total area of the pupil area and the iris area.

In one embodiment, an outer surface of the second lens unit has a curved protrusion.

To achieve the above, a robot of this disclosure includes a head portion and the above-mentioned realistic eyeball disposed on the head portion.

In one embodiment, the head portion includes an artificial eyelid, and the spherical display unit includes an effective display area. When the realistic eyeball in rotates, the artificial eyelid at least covers an edge of the effective display area.

In one embodiment, the robot controls the spherical display unit to flash and/or to display a code based on a scenario.

As mentioned above, in the realistic eyeball and the robot with the realistic eyeball of this disclosure, the spherical display unit is disposed in the inner concave surface of the first lens unit and includes a display surface, the display surface includes a pupil area and an iris area surrounding the pupil area, the pupil area or the iris area has at least one penetration region, the sensing unit is disposed in the spherical display unit and located corresponding to the at least one penetration region, and the pupil area and the iris area have different patterns and colors according to different simulated animals. Based on this design, the realistic eyeball can simulate the patterns and/or color changes presented by the eyes of different human races or animals, and the pattern displayed by the realistic eyeball is not distorted when the realistic eyeball is viewed from outside. In addition, the realistic eyeball of the present disclosure can realistically resemble the eyes of humans or any of other animals, thereby presenting the eyes with patterns and/or color changes that are unique to individual or specific animal, and can also express emotions through the displayed patterns.

Moreover, in one embodiment, the sensing unit may include a camera, which can receive the external light passing through the first lens unit and the penetration region, and then see (detect) the object in front of the realistic eyeball, so that the robot can perform corresponding actions accordingly. In another embodiment, the sensing unit may include a light detector, and the light detector may detect the light passing through the first lens unit and the penetration region. Then, the spherical display unit can change the dimensions of the pupil area and the iris area. In another embodiment, the sensing unit may include a distance detector, and the distance detector may detect the distance between the realistic eyeball and an object, thereby adjusting the distance between the object and the realistic eyeball (robot) according to the detected distance.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a perspective schematic diagram of a realistic eyeball according to an embodiment of this disclosure;

FIG. 1B is an exploded view of the realistic eyeball of FIG. 1A;

FIG. 1C is a top view of the realistic eyeball of FIG. 1A;

FIG. 1D is a perspective sectional view of the realistic eyeball of FIG. 1A;

FIG. 1E is a schematic diagram showing the relation between the display substrate of the spherical display unit and the sensing unit in the realistic eyeball of FIG. 1D;

FIG. 1F is a partial view of the spherical display unit according to the embodiment of this disclosure, wherein the spherical display unit is in a non-stretched state;

FIG. 1G is a partial view of the spherical display unit according to the embodiment of this disclosure, wherein the spherical display unit is in a stretched state;

FIG. 1H is a schematic diagram showing a manufacturing process of the realistic eyeball according to the embodiment of this disclosure;

FIGS. 2, 3A to 3D, 4A to 4B, 5, 6 and 7 are schematic diagrams showing the realistic eyeballs according to different embodiments of this disclosure; and

FIGS. 8 to 10 are schematic diagrams showing a robot according to different embodiments of this disclosure.

### DETAILED DESCRIPTION OF THE DISCLOSURE

The present disclosure will be apparent from the following detailed description, which proceeds with reference to the accompanying drawings, wherein the same references relate to the same elements.

The realistic eyeball of this disclosure can also be called as an artificial intelligence (AI) eyeball, which can simulate the patterns and/or color changes presented by eyes of human or animals. In addition, the simulated eyeballs in this article can realistically resemble the eyes of humans or different animals, can have patterns and/or color changes that are unique to individuals or specific animals, and can also express emotions through the patterns displayed by the eyeballs. The components appearing in the following embodiments are only used to illustrate their relative relationships and do not represent the proportions or sizes of the actual components.

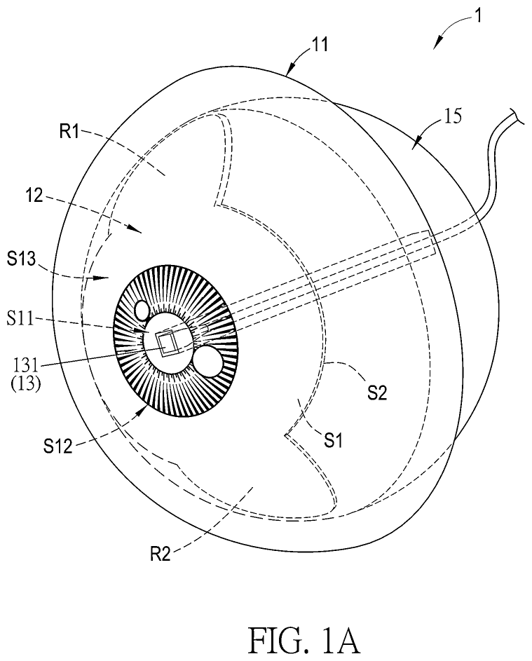

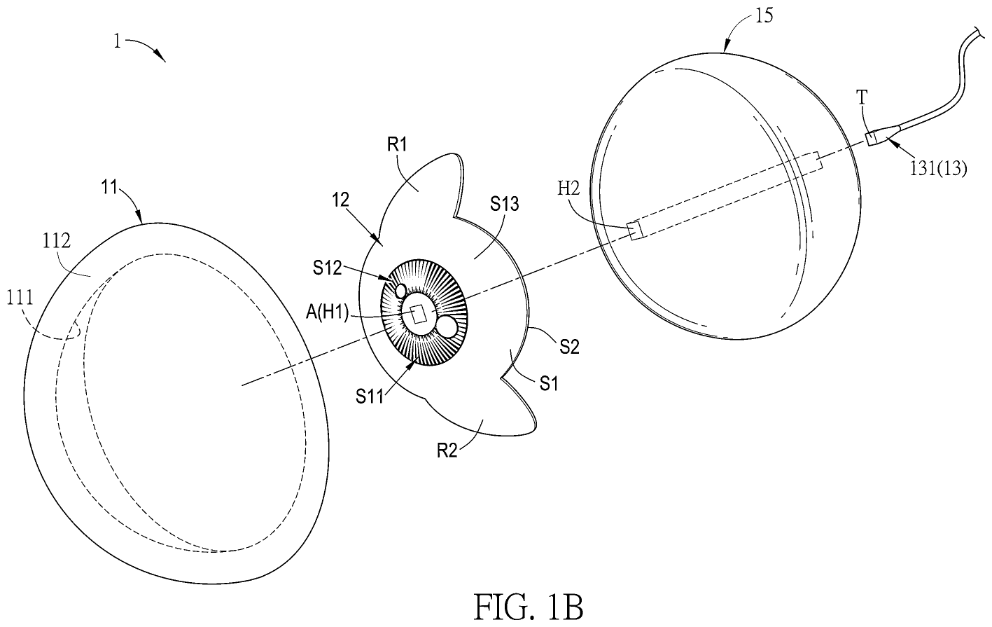

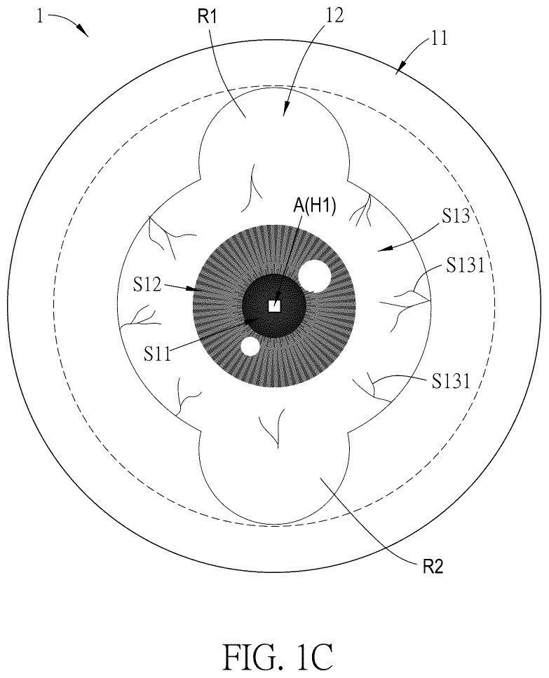

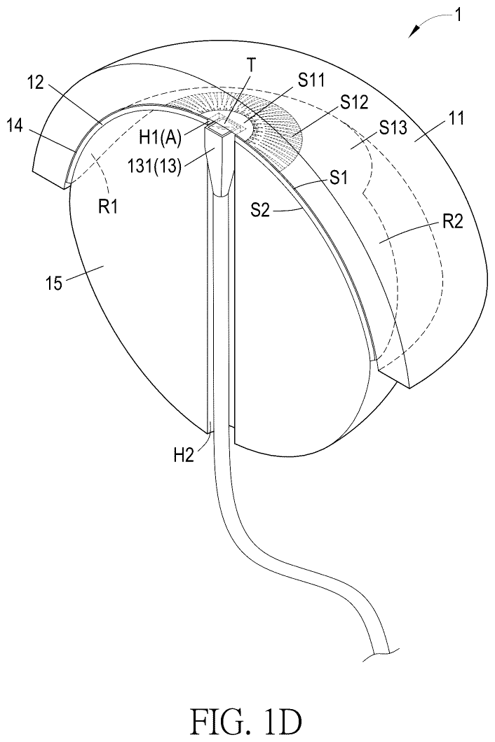

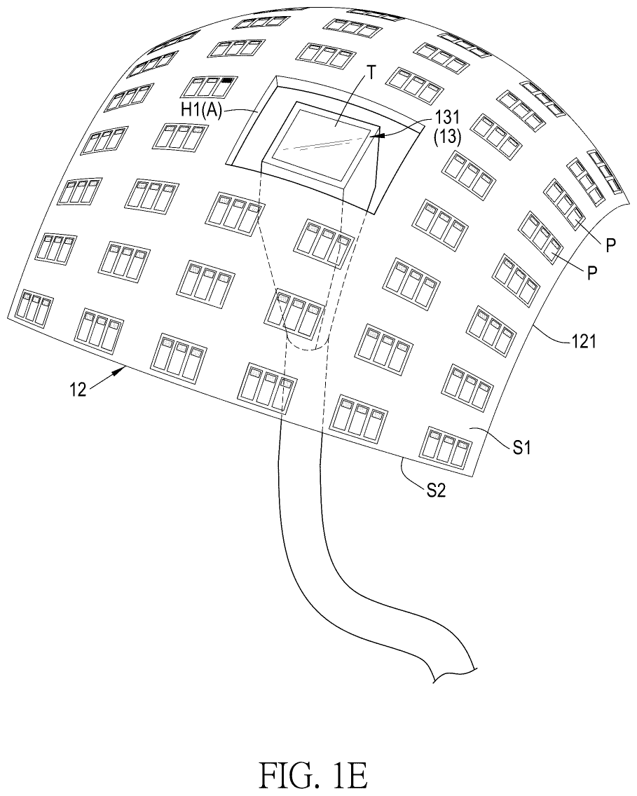

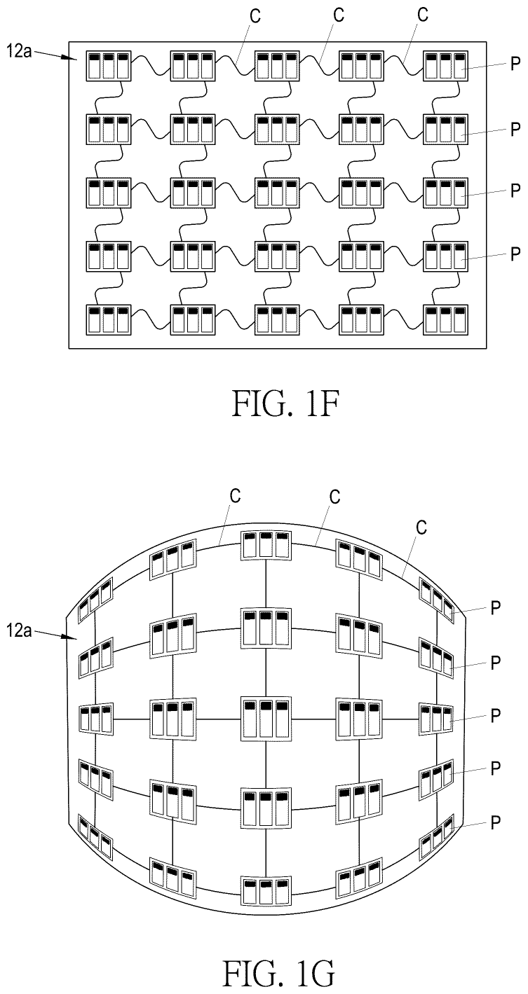

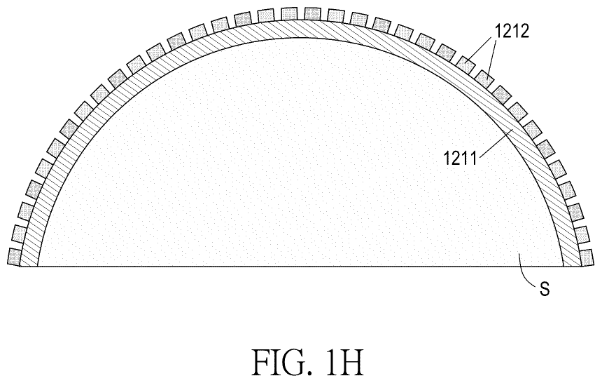

FIG. 1A is a perspective schematic diagram of a realistic eyeball according to an embodiment of this disclosure. FIG. 1B is an exploded view of the realistic eyeball of FIG. 1A, FIG. 1C is a top view of the realistic eyeball of FIG. 1A, and FIG. 1D is a perspective sectional view of the realistic eyeball of FIG. 1A. FIG. 1E is a schematic diagram showing the relation between the display substrate of the spherical display unit and the sensing unit in the realistic eyeball of FIG. 1D. FIG. 1F is a partial view of the spherical display unit according to the embodiment of this disclosure, wherein the spherical display unit is in a non-stretched state, and FIG. 1G is a partial view of the spherical display unit according to the embodiment of this disclosure, wherein the spherical display unit is in a stretched state. FIG. 1H is a schematic diagram showing a manufacturing process of the realistic eyeball according to the embodiment of this disclosure.

Referring to FIGS. 1A to 1E, a realistic eyeball 1 includes a first lens unit 11, a spherical display unit 12, and a sensing unit 13. In addition, the realistic eyeball 1 of this embodiment may further include an adhesive layer 14 and a filling unit 15. To be noted, the adhesive layer 14 is not shown in FIGS. 1A, 1B and 1C.

The first lens unit 11 has an inner concave surface 111 and an outer convex surface 112 opposite to the inner concave surface 111. In this embodiment, each of the inner concave surface 111 and the outer convex surface 112 has an arc-shaped surface. Specifically, the inner concave surface 111 is an arc-shaped surface that is concave inward, and the outer convex surface 112 is an arc-shaped surface that is convex outward. As shown in FIG. 1B, the first lens unit 11 is a convex lens and has an inner concave surface 111 that is concave inward and an outer convex surface 112 that is convex outward. The first lens unit 11 is made of a light-transmissive material such as, for example but not limited to, silica gel (e.g. silicone methyl, silophenyl, or the like). In one embodiment, the first lens unit 11 may be made of glass or polyimide (PI). Because the spherical curved surfaces of human eyeballs or different animals have different curvature radii, the curvatures of the spherical curved surfaces of the outer convex surface 112 and the inner concave surface 111 of the first lens unit 11 can be made according to humans or different animals.

The spherical display unit 12 is disposed on the inner concave surface 111 of the first lens unit 11. In addition, the spherical display unit 12 has a display surface S1, and the display surface S1 faces the inner concave surface 111 of the first lens unit 11. In this embodiment, the spherical display unit 12 is a stretchable display device, which is stretchable, flexible or bendable, and is a 3D curved physical display device that can conform to the 3D spherical shape after cutting. In the manufacturing process, the flat display device is cut before attaching to the 3D spherical body (filling unit 15), wherein the cut portion of the flat display device is a pixel-free region. In this case, the flat display device is cut is cut and then attached to the 3D spherical body (filling unit 15), thereby achieving the purpose of seamless or invisible seam lines.

In this embodiment, the spherical display unit 12 includes a display substrate 121 and a plurality of pixels P arranged on the display substrate 121 (see FIG. 1E). The display substrate 121 is stretchable, and the material thereof can be, for example but not limited to, PI. In the embodiment as shown in FIG. 1F, the spherical display unit 12a, which is not stretched, is a flat display device, and includes a plurality of pixels P and a plurality of signal lines C for connecting the pixels P. When the spherical display unit 12a is not stretched, the signal lines C are in a folded state. As shown in FIG. 1G, when the spherical display unit 12a is stretched, it can be extended into a curved display device. In the stretched spherical display unit 12a, the signal lines C can become straight lines, and the pixels P (and the signal lines C) of the spherical display unit 12a can still operate normally. In different embodiments, for example, the red, green and blue sub-pixels can also be connected by the signal lines C, and this disclosure is not limited thereto.

In order to dispose (fix) the spherical display unit 12 on the inner concave surface 111, the adhesive layer 14 (see FIG. 1D) is provided between the display surface S1 and the inner concave surface 111 of the first lens unit 11, so that the display surface S1 of the spherical display unit 12 can be fixed (attached) on the inner concave surface 111. Therefore, the curvature radius of the spherical curved surface of the spherical display unit 12 is substantially the same as the curvature radius of the spherical curved surface of the inner concave surface 111. The adhesive layer 14 can be an optical clear adhesive (OCA), an optical clear resin (OCR), or any of other transparent adhesive materials, and this disclosure is not limited thereto.

The display surface S1 of the spherical display unit 12 can include a pupil area S11 and an iris area S12 surrounding the pupil area S11, and the pupil area S11 and the iris area S12 have different patterns and colors according to different simulated animals. In this embodiment, at least one of the pupil area S11 and the iris area S12 has at least one penetration region A, which is a light-permeable region (including visible light or invisible light). In practice, the penetration region A can be a physical hole or a non-physical hole. In this embodiment, the penetration region A can be disposed in the pupil area S11 or in the iris area S12, or it can be distributed in the pupil area S11 and the iris area S12. This disclosure is not limited thereto. The shape of the penetration region A can be a circle, a quadrilateral (e.g. square, rectangle, rhombus, parallelogram, or trapezoid), an ellipse or any of other shapes. In this embodiment, the shape of the penetration region A is, for example, a square.

In addition, the display surface S1 of this embodiment may further include a sclera area S13, and the sclera area S13 surrounds the iris area S12. In this embodiment, the pupil area S11, the iris area S12 and the sclera area S13 together form a circular display area, and each of the pupil area S11, the iris area S12 and the sclera area S13 can display a corresponding pattern, thereby presenting the pattern and color corresponding to the eye of simulated animal. Specifically, the pupil area S11 is used to display the pupil pattern of the simulated eye, wherein the pupil area S11 can be black or brown and the shape thereof is not limited. The shape, pattern and/or color of the displayed pupil can be different for simulating the eyes of different human races or animals. The iris area S12 is used to display the iris pattern of the simulated eye. The shape, pattern and/or color of the displayed iris can be different for simulating the eyes of different human races or animals. The sclera area S13 is used to display the sclera pattern of the simulated eye. The shape, pattern and/or color of the displayed sclera can be different for simulating the eyes of different human races or animals. For example, as shown in FIG. 1C, the sclera area S13 can simulate the red lines S131 (e.g. blood vessels) present in the white portion (sclera) of human eye. Therefore, if the service robot works for a long time, the sclera area S13 can display the red lines S131, thereby simulating the real situation of the human eye that has bloodshot due to long-term working

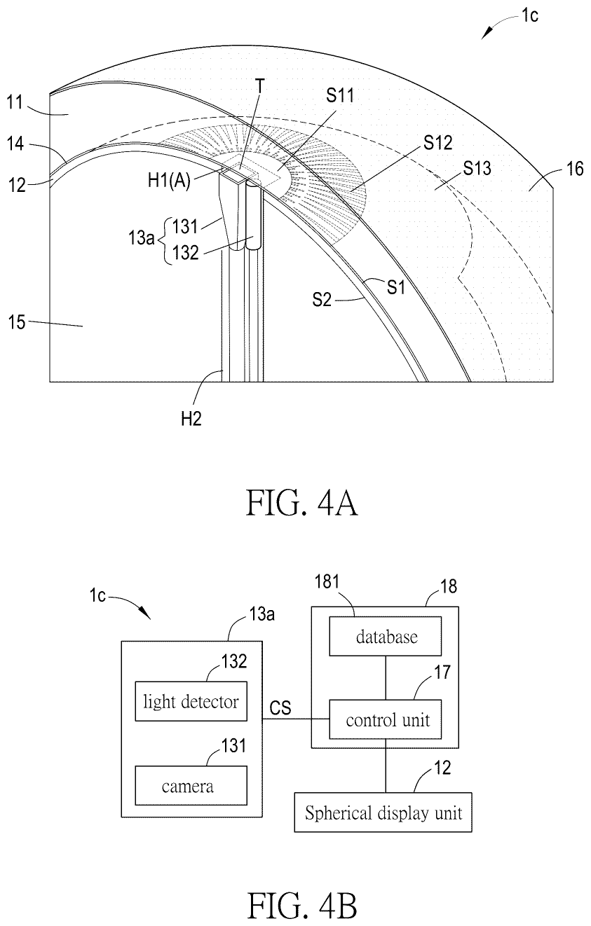

In this embodiment, the spherical display unit 12 may further include two ear portions R1 and R2, which are located at opposite sides of the periphery of the sclera area S13. The ear portions R1 and R2 are also attached to the inner concave surface 111. In one embodiment, the ear portion R1 or the ear portion R2 can be electrically connected to the main control board (e.g. the control circuit board 18 of FIG. 4B) via, for example, a flexible circuit board (e.g. COF), thereby controlling the spherical display unit 12, via the main control board, to display the pattern and/or color change of the eye to be simulated. In one embodiment, a pair of alignment symbols (e.g. 1) can be provided on the ear portions R1 and R2 respectively, and at the same time, another pair of alignment symbols (e.g. +) can be provided on the filling unit 15 and located corresponding to the alignment symbols of the ear portions R1 and R2. The configurations of the alignment symbols can facilitate the alignment and assembling of the spherical display unit 12 and the filling unit 15.

In addition, the spherical display unit 12 of this embodiment can further have a back surface S2 opposite to the display surface S1, and the filling unit 15 is attached to the back surface S2. In one embodiment, the filling unit 15 is a sphere or hemisphere made of a light-transmissive material or an opaque material. In this embodiment, the filling unit 15 is, for example, a sphere. In one embodiment, the material of the filling unit 15 may be the same as or different from that of the first lens unit 11. In this embodiment, the filling unit 15 is a sphere, and can be attached to the back surface S2 of the spherical display unit 12 via an adhesive (not shown), so that the overall shape of the realistic eyeball 1 can be similar to the shape of a real eyeball.

In one embodiment, the spherical display unit 12 can be an LED (light-emitting diode) display device, an OLED (organic light-emitting diode) display device, an LCD (liquid crystal display) device, or an e-paper display (EPD) device. The LED display device may include a Mini LED display device or a Micro LED (μLED) display device, but this disclosure is not limited thereto. In one embodiment, the spherical display unit 12 can be a self-luminous, transmissive or reflective display device. In particular, the spherical display unit 12 is preferably a bistable reflective display device because the bistable reflective display device does not consume power when the image is not renewed. This is similar to that the iris of a real human eye remains in the same state. In one embodiment, the mass transfer technology can be used to mass transfer a plurality of μLEDs onto a planar substrate (e.g. a PI substrate), and then a hemispherical jig can be used to bend or stretch the planar substrate to form the spherical display unit 12. After forming the spherical display unit 12, the hemispherical jig is removed. In another embodiment, please refer to FIG. 1H, a planar substrate (made of, for example, PI) can be placed on a hemispherical jig S to form the curved substrate 1211, and then a plurality of μLEDs 1212 (red, green and blue μLEDs) can be transferred on to the curved substrate 1211 by using mass transfer technology. Afterwards, the hemispherical jig S is removed to form the spherical display unit 12.

The sensing unit 13 is disposed at the spherical display unit 12 and located corresponding to a position of the at least one penetration region A. As shown in FIG. 1D, in this embodiment, the pupil area S11 has a penetration region A, and the penetration region A is provided with a first through hole H1 penetrating through the spherical display unit 12. In addition, as shown in FIG. 1E, the spherical display unit 12 of this embodiment is, for example, a micro LED (μLED) display device, which may include a display substrate 121. The display substrate 121 can be, for example but not limited to, a TFT (thin-film transistor) substrate, and the display substrate 121 has a plurality of pixels P arranged in a two-dimensional array. To be noted, the pixels P can be connected to a plurality of signal lines C (not shown). In addition, the display unit 12 may further include any of other layers and/or substrates, which is not limited in this disclosure. Since the penetration region A of this embodiment is a through hole (the first through hole H1), the penetration region A is not configured with any pixel P. The sensing unit 13 may include a sensor. For example, the sensor may include a visible light sensor, an infrared sensor, an ultrasonic sensor, or a combination thereof. In another case, the sensor may include a camera, a light detector, a distance detector, or a combination thereof. Specifically, the camera can be a visible light camera, an infrared camera, or an ultrasonic camera, the light detector can be a visible light detector, an infrared light detector, or an ultrasonic detector, and the distance detector can be a visible light distance detector, an infrared distance detector, or an ultrasonic distance detector. The configuration of the sensing unit 13 is optionally selected at least from the above examples depending on actual usage. In one embodiment, if the sensor is an ultrasonic sensor, the sensing unit 13 may include a plurality of ultrasonic sensors. In this case, since the sensitivity of the ultrasonic sensor is easily inaccurate while the air (bubbles) exists in the detecting direction, the display unit is preferably selected from the above-mentioned display devices other than the LCD display device. In other words, all layers of the preferred display device need to be tightly attached to one another, so that there are no (or almost no) air bubbles existing in front of the ultrasonic sensor (camera).

In this embodiment, the sensing unit 13 includes a sensor, which is a camera 131 for example. In one embodiment, the camera 131 (sensor) is a visible light camera (which can obtain color images) or an infrared (IR) camera (which can obtain black and white images). In this case, the camera 131 is, for example, a visible light camera. The camera 131 (sensor) is a micro camera. The filling unit includes a second through hole H2, which communicates with the first through hole H1. The camera 131 (sensing unit 13) is disposed in the first through hole H1 via the second through hole H2, and a top surface T of the camera 131 (sensor) faces the opening of the first through hole H1. In order to ensure the optical sensing sensitivity of the visible light camera 131 and ensure that the captured images are not distorted, the refractive index of each layer in front of the top surface T of the camera 131, including the display substrate 121, the adhesive layer 14 and the first lens unit 11, must be as consistent as possible (the same). In one embodiment, the sensing unit 13 can be fixed in the first through hole H1 by using, for example, a fixing member, glue, or any of other fixing methods, wherein the fixing methods are not limited. In one embodiment, the dimension of the penetration region A may be equal to or slightly larger than the dimension of the sensing unit 13, but smaller than the dimension of the pupil area S11 or the iris area S12. In one embodiment, the dimension of the camera 131 is, for example, about 0.65 mm.

As mentioned above, in the realistic eyeball 1 of this embodiment, the pupil area S11, the iris area S12 and the sclera area S13 of the spherical display unit 12 can respectively display corresponding patterns and/or color changes, and the pupil area S11, the iris area S12 and the sclera area S13 have different patterns and colors according to different simulated animals. In this embodiment, the patterns and/or color changes to be displayed (simulated) in the pupil area S11, the iris area S12 and the sclera area S13 can be stored in the aforementioned main control board, and the main control board can control the pupil area S11, the iris area S12 and the sclera area S13 of the spherical display unit 12 to respectively display the corresponding patterns and/or color changes, thereby simulating the patterns and/or color changes of the eyes of human or different animals. Furthermore, the pupil area S11, the iris area S12 and the sclera area S13 of the spherical display unit 12 can also simulate the patterns and/or colors unique to an individual or a specific animal, thereby expressing a specific emotion, such as happiness or sadness.

In addition, when looking down to view the patterns displayed on the spherical display unit 12 in the direction from the outer convex surface 112 of the first lens unit 11 to the spherical display unit 12, since the spherical display unit 12 is disposed (attached) on the inner concave surface 111 of the first lens unit 11, when the realistic eyeball 1 is viewed from the outside, the patterns displayed in the pupil area S11, the iris area S12 and the sclera area S13 are not distorted. In addition, the camera 131 of this embodiment can receive the external light passing through the first lens unit 11 and the transmission area A (the first through hole H1), and then see (detect) the object in front of the realistic eyeball 1 so as to perform corresponding reactions accordingly.

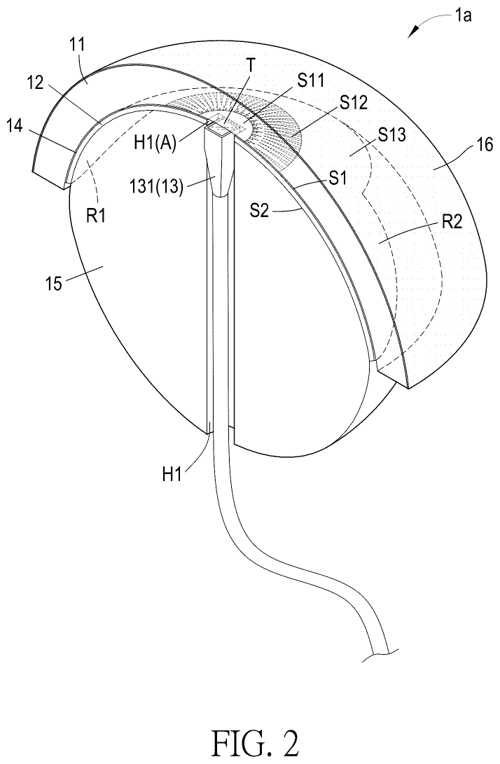

FIGS. 2 to 7 are schematic diagrams showing the realistic eyeballs according to different embodiments of this disclosure.

The component configurations and connections of the realistic eyeball 1a of this embodiment of FIG. 2 are mostly the same as those of the realistic eyeball 1 of the previous embodiment. Unlike the realistic eyeball 1 of the previous embodiment, the realistic eyeball 1a further includes a functional layer 16, which is disposed on the outer convex surface 112 of the first lens unit 11. In this embodiment, the functional layer 16 is a light-permeable film or layer, such as, for example but not limited to, an anti-scratch film, an anti-glare film, an anti-reflection film, an anti-fingerprint film, or a waterproof and antifouling film, or any combination thereof. This disclosure is not limited thereto.

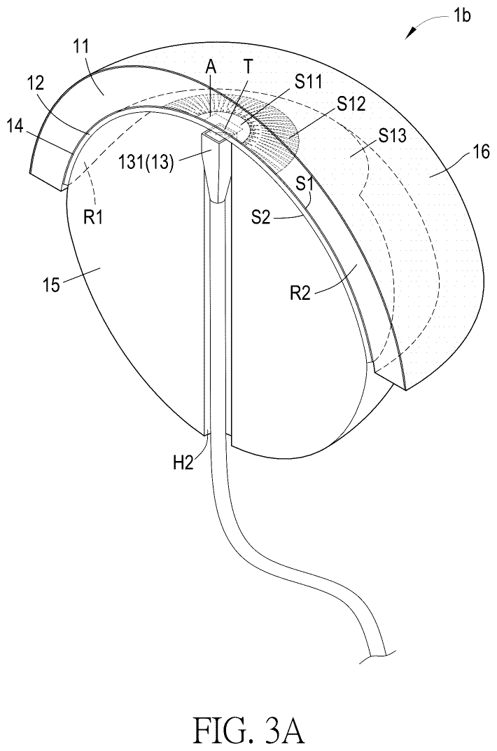

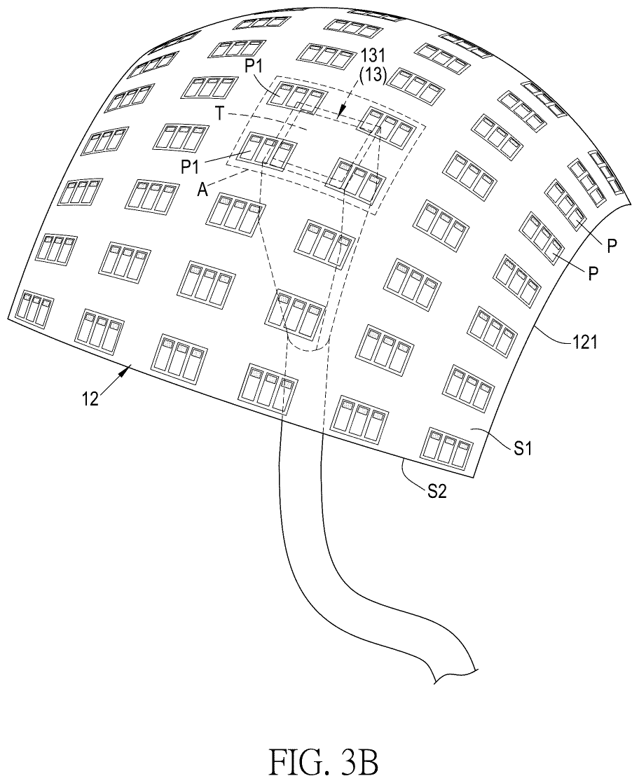

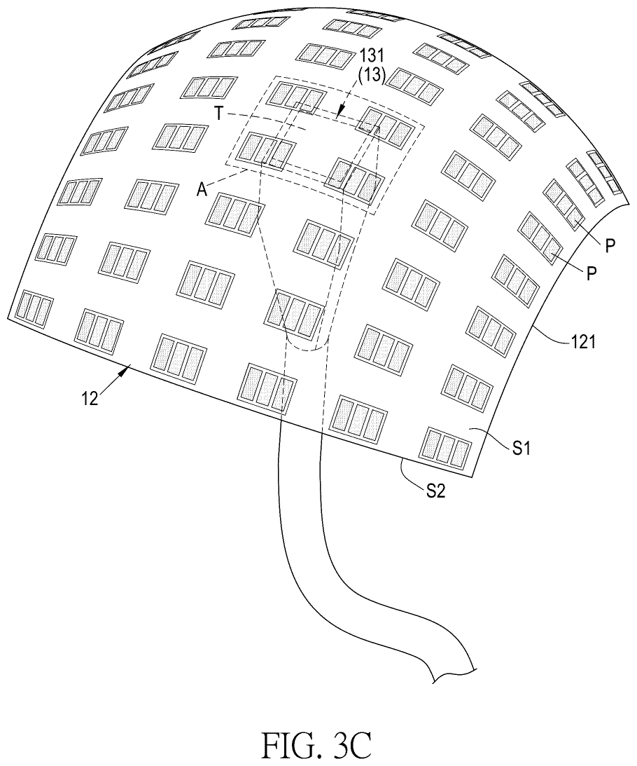

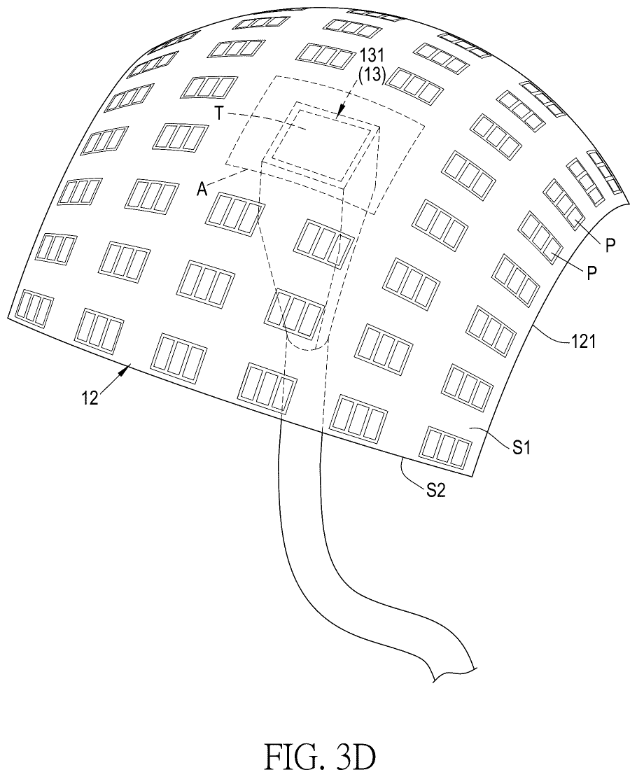

The component configurations and connections of the realistic eyeball 1b of this embodiment of FIGS. 3A and 3B are mostly the same as those of the realistic eyeball 1a of the previous embodiment. Unlike the realistic eyeball 1a of the previous embodiment, in the realistic eyeball 1b, the penetration region A is not a physical hole, but a solid area through which the light can pass. As shown in FIG. 3B, the penetration region A of this embodiment is provided with a plurality of pixels P, and the sensing unit 13 (camera 131) is arranged on the back surface S2 of the spherical display unit 12 via the second through hole H2 of the filling unit 15, and the top surface T of the camera 131 (sensing unit 13) faces the penetration region A. Specifically, the penetration region A of the spherical display unit 12 of this embodiment is provided with a plurality of specially designed pixels P, wherein a part of each pixel P in the penetration region A (transparent area P1) is specially designed to be transparent through which light can pass. These transparent areas P1 form the penetration region A. Therefore, the light passing through the transparent areas P1 can also enter the camera 131. In one embodiment, a part of each pixel P in the penetration region A is designed as a transparent area P1 and is located only in the pupil area S11, and the pixels in other areas are designed as normal pixels. In one embodiment, the camera 131 (sensing unit 13) can be fixed to the back surface S2 of the spherical display unit 12 by using, for example, a fixing member, glue, or any of other fixing methods, wherein the fixing methods are not limited.

In another embodiment, as shown in FIG. 3C, when the camera 131 is an infrared camera, the display substrate 121 is an infrared permeable substrate, and the material thereof includes, for example but is not limited to, glass, polymethyl methacrylate (PMMA), or polycarbonate. It can be understood that the pixels P in the penetration region A as shown in FIG. 3C can be normal pixels that can normally display images, and there is no need to specially configure the transparent area P1. In this case, the infrared camera can obtain black and white images for determination by the control circuit. In another embodiment, when the sensor is an infrared light detector or an infrared distance detector, the pixels P in the penetration region A can be normal pixels that normally display images, and no special design is required.

Unlike the aspect as shown in FIG. 3C, the penetration region A of the aspect as shown in FIG. 3D is a transparent area and is configured without any pixels P, the sensing unit 13 (camera 131) is disposed (fixed) on the back surface S2, and the top surface T of the camera 131 (sensing unit 13) faces the penetration region A. The reason of not configuring pixel P in the penetration region A is that when the realistic eyeball of the embodiment of the present disclosure is viewed from a certain distance (e.g. 1 meter away), because the dimension of the camera 131 is very small, even if the penetration region A is not configured with the pixel P, the camera 131 is still not easily visible and does not affect the realistic effect of the realistic eyeball. The design in which the pixel P is not provided in the penetration region A as shown in FIG. 3D can also be applied to the aspect of FIG. 3B.

FIG. 4B is a functional block diagram of the realistic eyeball 1c as shown in FIG. 4A. The component configurations and connections of the realistic eyeball 1c of this embodiment of FIGS. 4A and 4B are mostly the same as those of the realistic eyeball 1a of the previous embodiment. Unlike the realistic eyeball 1a of the previous embodiment, in the realistic eyeball 1c of this embodiment, the sensing unit 13a further includes, in addition to the camera 131, a light detector 132. In this case, the camera 131 and the light detector 132 are both installed in the first through hole H1 via the second through hole H2, wherein the fixing method thereof is not limited. It can be understood that the light detector 132 of this embodiment can be replaced by a distance detector. In another case, an additional distance detector can be provided and installed next to the camera 131 and the light detector 132, and this disclosure is not limited thereto.

In addition, the realistic eyeball 1c can further include a control circuit board 18, which may be provided, for example, in the head portion or the body portion of the robot. The control circuit board 18 is electrically connected to the spherical display unit 12 and the sensing unit 13. The control circuit board 18 is a main control board and may include a database 181. The database 181 may store a plurality of patterns and colors for the pupil area S11 and the iris area S12. Furthermore, the database 181 can also store a plurality of patterns and colors for the sclera area S13. In this embodiment, the patterns and/or color changes to be displayed (simulated) in the pupil area S11, the iris area S12 and the sclera area S13 vary according to different simulated animals, and can be inputted from the outside or stored in the database 181 of the control circuit board 18. The present disclosure is not limited thereto. For example, the patterns and colors of the pupil area S11, the iris area S12, and the sclera area S13 of human are different from the patterns and colors of the pupil area S11, the iris area S12, and the sclera area S13 of a cat or dog. Moreover, the patterns and colors of the pupil area S11, the iris area S12, and the sclera area S13 of different human races or different cats or dogs are different. These patterns and/or color changes can be stored in the database 181 in advance. When the control circuit board 18 knows what animal (including human) is selected for simulation, the corresponding patterns and colors of the pupil area S11, the iris area S12, and the sclera area S13 can be found in the database 181. Then, the spherical display unit 12 can display the found patterns and colors of the pupil area S11, the iris area S12, and the sclera area S13 of the animal to be simulated.

In addition, the realistic eyeball 1c can further include a control unit 17, which can be electrically connected to the sensing unit 13a (camera 131, light detector 132) and the spherical display unit 12 respectively through a flexible circuit board (e.g. COF). In this embodiment, the control unit 17 may be composed of software, hardware or firmware. The control unit 17 is disposed on the control circuit board 18. In another case, the control unit 17 can be disposed on an independent circuit board, and this disclosure is not limited thereto. The control unit 17 can change the displayed patterns and colors of the spherical display unit 12 according to the sensing results of the sensing unit 13a (camera 131, light detector 132) (as well as the patterns and colors stored in the database 181). Moreover, the control unit 17 can further change the dimensions of the displayed patterns. In one embodiment, as shown in FIGS. 4A and 4B, after the image of the pupil area S11, the iris area S12 and the sclera area S13 of the animal to be simulated are obtained by, for example, the camera 131, the control unit 17 then controls the spherical display unit 12 to display the corresponding pattern and color based on the images obtained by the camera 131. In another embodiment, the light detector 132 can sense the light passing through the first lens unit 11 and the penetration region A and output a sensing signal CS, so that the control unit 17 can change the displayed patterns and colors of the pupil area S11 and the iris area S12 of the spherical display unit 12 according to the sensing signal CS. For example, the control unit 17 can change the dimensions of the pupil area S11 and the iris area S12. In this case, when the dimension of the pupil area S11 decreases, the dimension of the iris area S12 increases, so that the sum of the areas of the pupil area S11 and the iris area S12 remains unchanged. In another case, when the dimension of the pupil area S11 increases, the dimension of the iris area S12 decreases.

For example, when the light detector 132 senses an external strong light, the control unit 17 can change the displayed pattern of the spherical display unit 12. Specifically, the control unit 17 can control to decrease the dimension of the pupil area S11 and increase the dimension of the iris area S12. In another case, when the light detector 132 senses that the external environment is dark, the control unit 17 can control to increase the dimension of the pupil area S11 so as to increase the light entering the pupil area S11, and decrease the dimension of the iris area S12. This can simulate the real reaction of the eye to strong light or dark. In one embodiment, the light detector 132 may be a visible light detector or an infrared light detector, and this disclosure is not limited thereto.

In another embodiment, the sensing unit includes a distance detector. When the distance detector detects that the distance between an object and the realistic eyeball is less than a target distance, it can output a sensing signal, and the control unit 17 can adjust the distance between the realistic eyeball (the robot) and the object based on the sensing signal. For example, the control unit 17 can control to increase the distance between the realistic eyeball (the robot) and the object. In one embodiment, the light detector 132 or the distance detector is a micro-size detector. In one embodiment, the size of the light detector 132 or the distance detector may be, for example, 0.5 to 1.0 mm, but this disclosure is not limited thereto.

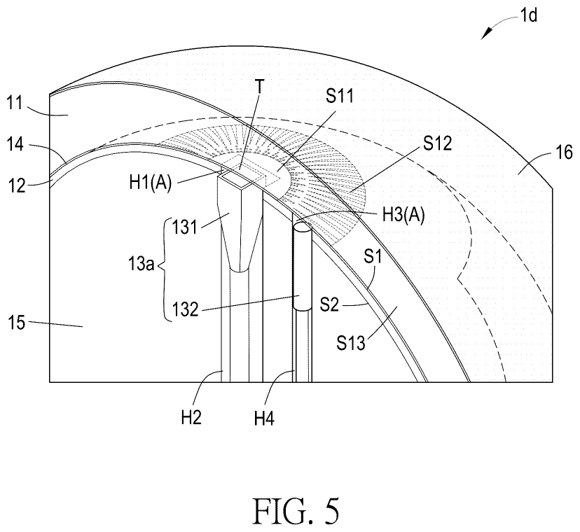

The component configurations and connections of the realistic eyeball 1d of this embodiment of FIG. 5 are mostly the same as those of the realistic eyeball 1a of the previous embodiment. Unlike the realistic eyeball 1a of the previous embodiment, in the realistic eyeball 1d of this embodiment, the display unit has a plurality of penetration regions A (e.g. two penetration regions A), and the penetration regions A are located in the pupil area S11 and the iris area S12. In addition, the sensing unit 13a also includes a plurality of sensors of different types (e.g. two different sensors), and the sensors of different types are respectively arranged in the transmission areas A. In this case, one penetration regions A (the first through hole H1) is disposed in the pupil area S11 and is configured with a camera 131. The other penetration regions A (the third through hole H3) is disposed in the iris area S12 and is configured with a light detector 132. Herein, the filling unit 15 includes a fourth through hole H4 corresponding to the third through hole H3. In another embodiment, the plurality of penetration regions A may be all disposed in the pupil area S11 or all disposed in the iris area S12, and this disclosure is not limited thereto.

To be understood, in the realistic eyeballs 1c and 1d of the above embodiments, the penetration region A is a physical hole (through hole), but this disclosure is not limited thereto. Those skilled in the art can apply the features of the above embodiments to any other embodiment that the penetration region A is not a physical hole.

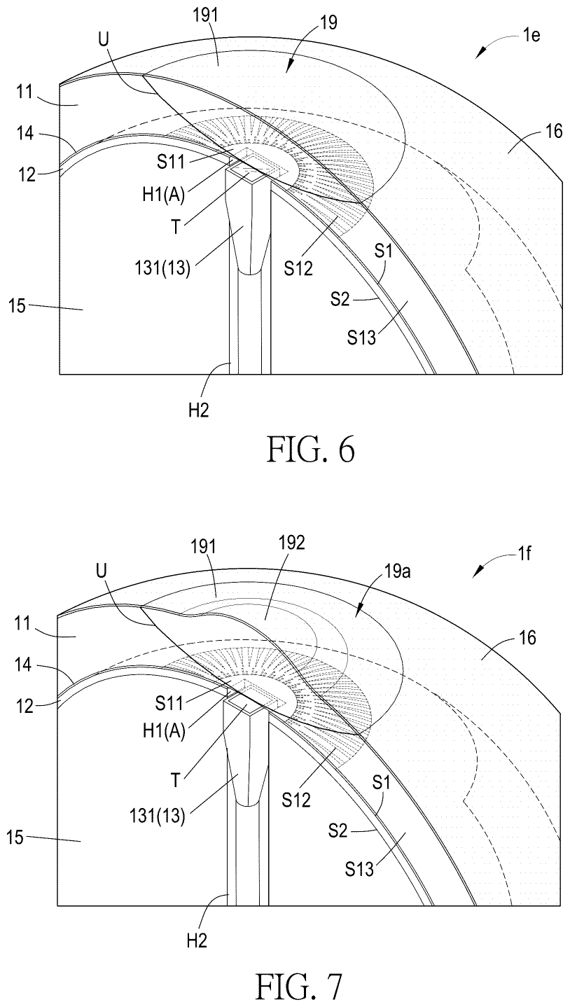

The component configurations and connections of the realistic eyeball 1e of this embodiment of FIG. 6 are mostly the same as those of the realistic eyeball 1a of the previous embodiment. Unlike the realistic eyeball 1a of the previous embodiment, the realistic eyeball 1e further includes a second lens unit 19. In this embodiment, the outer convex surface 112 of the first lens unit 11 includes a recess U located corresponding to the pupil area S11 and the iris area S12, and the second lens unit 19 is disposed in the recess U. In this case, the second lens unit 19 is a biconvex lens, and its shape matches the recess U. The second lens unit 19 can be attached to the recess U by, for example, adhesive glue. In another case, the first lens unit 11 and the second lens unit 19 can be integrally formed as one piece. This disclosure is not limited thereto. In addition, in the top-view direction of the realistic eyeball 1e, the area of the second lens unit 19 is substantially the same as the total area of the pupil area S11 and the iris area S12, thereby enlarging the patterns of the pupil area S11 and the iris area S12.

The component configurations and connections of the realistic eyeball If of this embodiment of FIG. 7 are mostly the same as those of the realistic eyeball 1e of the previous embodiment. As shown in FIG. 7, the shape of the second lens unit 19a of the realistic eyeball If of this embodiment is different from that of the second lens unit 19 of the realistic eyeball 1e of the previous embodiment. In this embodiment, the center portion of the outer surface 191 of the second lens unit 19a has a curved protrusion 192. The second lens unit 19a can be attached to the recess U by, for example, adhesive glue, or the first lens unit 11 and the second lens unit 19a can be integrally formed as one piece. This disclosure is not limited thereto.

The purpose of configuring the second lens unit 19 or 19a is as follow. The real eyeball has a structure similar to the second lens unit 19 or 19a, which can enlarge the pattern of the pupil area S11 and the iris area S12. In the embodiments of FIGS. 6 and 7, the configuration of the second lens unit 19 or 19a can enlarge the patterns of the pupil area S11 and the iris area S12, so that the realistic eyeballs 1e and If can act closer to the real eyeball (including the pupil and iris patterns). Accordingly, the realistic eyeballs 1e and If can more realistically resemble human or animal eyes. In addition, it can be understood that the above-mentioned functional layer 16 can be provided on the outer surface 191 of the second lens unit 19 or the outer surface 191 and the curved protrusion 192 of the second lens unit 19a.

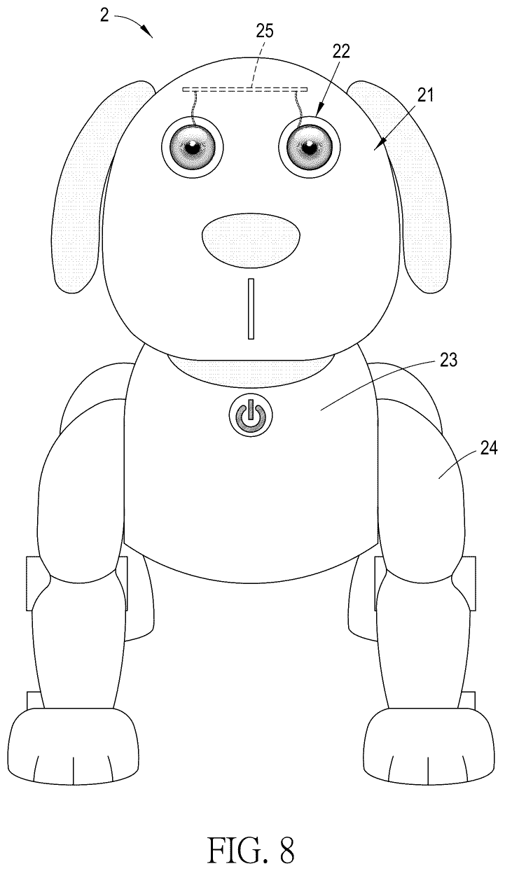

FIGS. 8 to 10 are schematic diagrams showing a robot according to different embodiments of this disclosure.

Referring to FIG. 8, a robot 2 includes a head portion 21 and at least one realistic eyeball 22, and the realistic eyeball 22 is arranged on the head portion 21. In this embodiment, the robot 2 includes, for example, two realistic eyeballs 22 arranged on the head portion 21. The realistic eyeball 22 can be selected from any one of the above-mentioned realistic eyeballs 1 and 1a to 1f, or any modifications thereof. The specific technical contents of the realistic eyeball 22 have been described in the above embodiments and will not be described further here.

In this embodiment, the robot 2 further includes a body portion 23, four limbs 24 and a control circuit board 25. The control circuit board 25 can be the aforementioned control circuit board 18 (including the database 181) as shown in FIG. 4B, and is installed in the head portion 21. The robot 2 can change the patterns and colors of the pupil area, the iris area and the sclera area by the control circuit board 25 according to the owner or autonomous control. This disclosure is not limited thereto. In this case, the robot 2 simulates a terrestrial animal such as, for example but not limited to, a pet robot (robot dog). In different embodiments, the robot 2 can be any of other terrestrial animals (e.g. a robot cat, a robot bird, a robot pig, or the like), any of aquatic animals (e.g. a robot fish, a robot dolphin, or the like), or a service robot, and this disclosure is not limited thereto.

In one application example, the pet robot is a robot dog. Because most pet dogs have shorter lifespans than humans, the owner can store the information about the patterns and colors of the robot dog's eyeballs (including the pupil areas, iris areas and sclera areas) in advance while the dog is still alive. When the dog passes away, the stored information can be used to setup the realistic eyeballs, which are then applied to the pet robot (robot dog). When the owner sees the pet robot's expression and eyes, it seems that the dog is still alive.

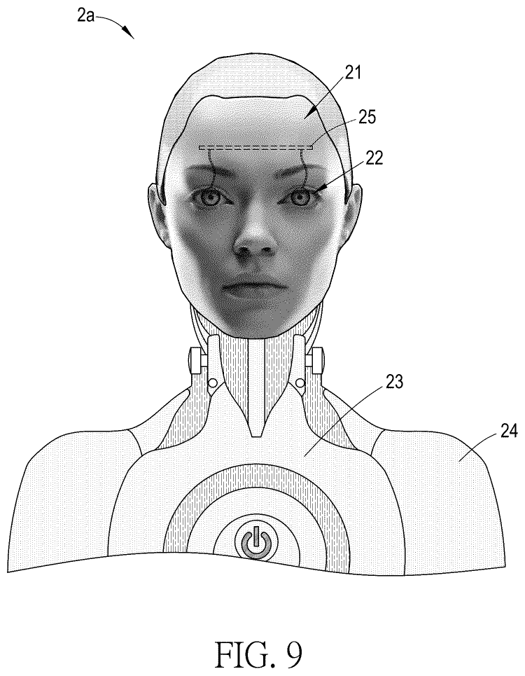

In addition, the component configurations and connections of the robot 2a of this embodiment of FIG. 9 are mostly the same as those of the robot 2 of the previous embodiment. Unlike the robot 2 of the previous embodiment, the robot 2a is a service robot. The service robot 2a is also installed with the realistic eyeballs 22, and the patterns and colors of the spherical display unit (including the pupil areas, the iris areas and the sclera areas) of the realistic eyeballs 22 can be changed by the control circuit board 25 according to the owner or autonomous control, thereby simulating the patterns and/or color changes of human eyes to express emotions. For example, the pupil may constrict when exposed to strong light, the sclera area may have obvious red lines (blood vessels) when working for a long time or rubbing the eyes, or the eyes may tear when encountering sad situations, etc.

In some application examples, the aforementioned robot 2 or 2a can enable the control circuit board 25 to control the spherical display unit of the realistic eyeballs 22 to generate a warning function according to a scenario. The warning function may include, for example, flashing or/and displaying a fault code. For example, when the robot acknowledges (from the Internet or from its own camera detection) that there is a fire alarm in the building where it is located, it can actively control the spherical display unit of the realistic eyeballs 22 to generate, for example, a red or green light flash (may also display the warning codes). Moreover, if the robot is equipped with a speaker, it can also output a voice reminder. When the robot detects that its battery power is lower than a threshold value, it can actively control the spherical display unit of the realistic eyeballs 22 to generate, for example, a red or yellow light flash (may also display the warning codes). Moreover, if the robot is equipped with a speaker, it can also output a voice reminder. When the robot detects a malfunction in its own mechanism, it can actively control the spherical display unit of the realistic eyeballs 22 to generate a code (e.g. an error code, and may also flash). If the robot is equipped with a speaker, it can also output a voice reminder to notify and assist the maintenance personnel to perform maintenance. The aforementioned scenarios including fire alarm, low battery and mechanical malfunction are only examples and are not used to limit the present disclosure.

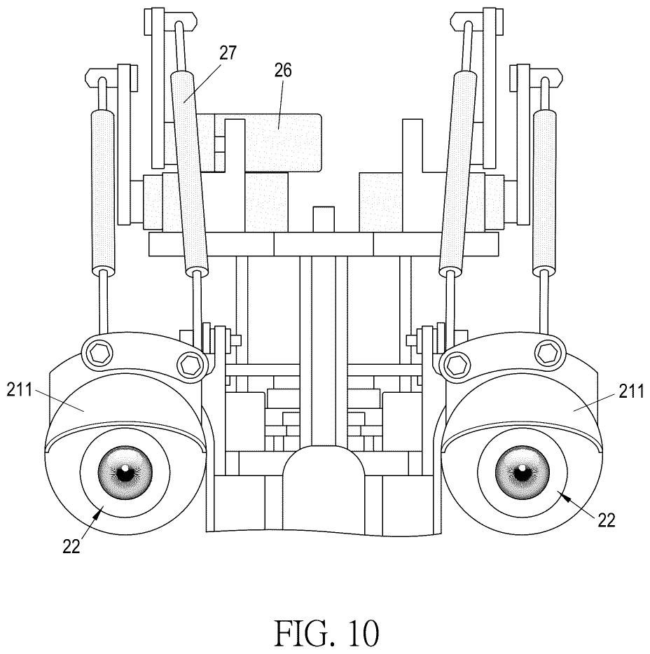

As shown in FIG. 10, a linking mechanism can be provided in the head portion of the robot to control the rotation of the realistic eyeballs 22. For example, a plurality of actuators 26 are provided, and the actuators 26 are connected to the two realistic eyeballs 22 through a plurality of connecting rods 27. Accordingly, the actuators 26 and the connecting rods 27 can control the rotation of the realistic eyeballs 22. In addition, the head portion 21 of the robot 2a may include an artificial eyelid 211, and the spherical display unit has an effective display area. The effective display area can be defined as an area in the display surface of the spherical display unit that can display images. When the realistic eyeballs 22 rotate, for example, to the maximum angle, the artificial eyelids 211 can cover at least the edge of the effective display area of the spherical display unit. In the embodiment of FIG. 10, the effective display area of the realistic eyeball 22 includes the aforementioned pupil area, iris area and sclera area. Therefore, when the robot 2a rotates the realistic eyeballs 22, the artificial eyelids 211 still cover the edges of the pupil area, the iris area and the scleral area.

In summary, in the realistic eyeball and the robot with the realistic eyeball of this disclosure, the spherical display unit is disposed in the inner concave surface of the first lens unit and includes a display surface, the display surface includes a pupil area and an iris area surrounding the pupil area, the pupil area or the iris area has at least one penetration region, the sensing unit is disposed in the spherical display unit and located corresponding to the at least one penetration region, and the pupil area and the iris area have different patterns and colors according to different simulated animals. Based on this design, the realistic eyeball can simulate the patterns and/or color changes presented by the eyes of different human races or animals, and the pattern displayed by the realistic eyeball is not distorted when the realistic eyeball is viewed from outside. In addition, the realistic eyeball of the present disclosure can realistically resemble the eyes of humans or any of other animals, thereby presenting the eyes with patterns and/or color changes that are unique to individual or specific animal, and can also express emotions through the displayed patterns.

Moreover, in one embodiment, the sensing unit may include a camera, which can receive the external light passing through the first lens unit and the penetration region, and then see (detect) the object in front of the realistic eyeball, so that the robot can perform corresponding actions accordingly. In another embodiment, the sensing unit may include a light detector, and the light detector may detect the light passing through the first lens unit and the penetration region. Then, the spherical display unit can change the dimensions of the pupil area and the iris area. In another embodiment, the sensing unit may include a distance detector, and the distance detector may detect the distance between the realistic eyeball and an object, thereby adjusting the distance between the object and the realistic eyeball (robot) according to the detected distance.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A realistic eyeball, comprising:
a first lens unit having an inner concave surface;
a spherical display unit disposed on the inner concave surface of the first lens unit, wherein the spherical display unit has a display surface, the display surface comprises a pupil area and an iris area surrounding the pupil area, and at least one of the pupil area and the iris area has at least one penetration region; and
a sensing unit disposed on the spherical display unit, wherein the sensing unit is disposed corresponding to a position of the at least one penetration region;
wherein, the pupil area and the iris area have different patterns and colors according to different simulated animals.

2. The realistic eyeball of claim 1, wherein the spherical display unit further comprises a plurality of pixels arranged on a display substrate, and the display substrate is stretchable, flexible or bendable.

3. The realistic eyeball of claim 1, wherein a curvature radius of a spherical curved surface of the spherical display unit is substantially equal to a curvature radius of a spherical curved surface of the inner concave surface.

4. The realistic eyeball of claim 1, further comprising:
a filling unit, wherein the spherical display unit further comprises a back surface opposite to the display surface, and the filling unit is attached to the back surface.

5. The realistic eyeball of claim 4, wherein the penetration region is configured with a first through hole, the filling unit is configured with a second through hole communicating with the first through hole, the sensing unit is disposed in the first through hole via the second through hole, and a top surface of the sensing unit faces an opening of the first through hole.

6. The realistic eyeball of claim 4, wherein the penetration region is configured with a plurality of pixels, the filling unit comprises a second through hole, the sensing unit is disposed at the back surface via the second through hole, and a top surface of the sensing unit faces the penetration region.

7. The realistic eyeball of claim 6, wherein a part of each of the pixels in the penetration region is a transparent area, and the transparent areas define the penetration region.

8. The realistic eyeball of claim 1, wherein the penetration region is a transparent area and is configured without any pixel, the spherical display unit further comprises a back surface opposite to the display surface, the sensing unit is disposed on the back surface, and a top surface of the sensing unit faces the penetration region.

9. The realistic eyeball of claim 1, wherein the sensing unit comprises a sensor, and the sensor comprises a visible-light sensor, an infrared sensor, or an ultrasonic sensor, or a combination thereof.

10. The realistic eyeball of claim 9, wherein the sensor comprises a camera, a light detector, or a distance detector, or a combination thereof.

11. The realistic eyeball of claim 1, wherein the spherical display unit comprises a display substrate, the display substrate has a plurality of pixels, and when the sensing unit comprises an infrared sensor, the display substrate is permeable by an infrared light.

12. The realistic eyeball of claim 1, wherein at least one of the pupil area and the iris area has a plurality of the penetration regions, the sensing unit comprises sensors of different types, and the sensors of different types are arranged in the penetration regions, respectively.

13. The realistic eyeball of claim 1, wherein the display surface further comprises a sclera area surrounding the iris area, and each of the pupil area, the iris area and the sclera area displays one of the patterns and one of the colors.

14. The realistic eyeball of claim 1, further comprising:
a control circuit board electrically connected to the spherical display unit and the sensing unit, wherein the control circuit board comprises a database, and the database stores a plurality of the patterns and colors of the pupil area and the iris area.

15. The realistic eyeball of claim 1, further comprising:
a control unit electrically connected to the sensing unit and the spherical display unit;
wherein, the sensing unit comprises a light sensor, the light sensor receives a light passing through the first lens unit and the penetration region and outputs a sensing signal, and the control unit changes a dimension of the pupil area and a dimension of the iris area of the display unit based on the sensing signal.

16. The realistic eyeball of claim 1, further comprising:
a second lens unit, wherein the first lens unit further comprises an outer convex surface opposite to the inner concave surface, the outer convex surface comprises a recess located corresponding to the pupil area and the iris area, the second lens unit is disposed in the recess, and in a top-view direction of the realistic eyeball, an area of the second lens unit is substantially equal to a total area of the pupil area and the iris area.

17. The realistic eyeball of claim 16, wherein an outer surface of the second lens unit has a curved protrusion.

18. A robot, comprising:
a head portion; and
a realistic eyeball disposed on the head portion, wherein the realistic eyeball comprises a first lens unit, a spherical display unit and a sensing unit, the first lens unit has an inner concave surface, the spherical display unit is disposed on the inner concave surface of the first lens unit, the spherical display unit has a display surface, the display surface comprises a pupil area and an iris area surrounding the pupil area, at least one of the pupil area and the iris area has at least one penetration region, the sensing unit is disposed on the spherical display unit, and the sensing unit is disposed corresponding to a position of the at least one penetration region;
wherein, the pupil area and the iris area have different patterns and colors according to different simulated animals.

19. The robot of claim 18, wherein the head portion comprises an artificial eyelid, the spherical display unit comprises an effective display area, and when the realistic eyeball rotates, the artificial eyelid at least covers an edge of the effective display area.

20. The robot of claim 18, wherein the robot controls the spherical display unit to flash and/or to display a code based on a scenario.
